(19) United States
(12) Patent Application Publication
(10) Pub. No.: US 2021/0404786 A1
(43) Pub. Date: Dec. 30, 2021

(54) MEASURING TOOL

(71) Applicant: MRDESIGN LLC, Kansas City, MO (US)

(72) Inventors: Jesse Williams, Kansas City, MO (US); Greta Wills, Kansas City, MO (US)

(21) Appl. No.: 17/362,487

(22) Filed: Jun. 29, 2021

Related U.S. Application Data
(60) Provisional application No. 63/045,637, filed on Jun. 29, 2020.

(51) Int. Cl. G01B 3/08; G01C 9/02

(52) U.S. Cl. CPC G01B 3/08; G01C 9/02

(57) ABSTRACT

A measuring tool includes outer and inner tubes. The outer tube telescopically receives the inner tube. Marking indicia are provided on the tubes for measuring a distance between objects. Each tube includes feet for abutting a respective object or anchoring a respective tube end. A measuring method comprises the steps of providing a measuring tool with outer and inner tubes each having a respective end mounting a foot. The measuring tool is placed between objects with each foot engaging a respective object. The measuring tool is telescopically adjusted to determine the distance between the objects.

### CROSS-REFERENCE TO RELATED APPLICATION

This application claims priority in U.S. Provisional Patent Application No. 63/045,637, filed Jun. 29, 2020, which is incorporated herein by reference.

### BACKGROUND OF THE INVENTION

### 1. Field of the Invention

The present invention relates generally to measuring devices, and more particularly to a measuring device for efficiently determining compliance with building codes and standards, such as the criteria for building accessibility in the Americans with Disabilities Act (ADA), 42 U.S.C. §§ 12101 et seq.

### 2. Description of the Related Art

Building codes are generally intended to protect the public by requiring habitable structures (e.g., commercial, residential, institutional, etc.) to comply with minimum standards. Such standards cover building configurations, materials, fire safety, ingress and egress, and other matters. The ADA extends accessibility to individuals with a wide range of physical disabilities by setting compliance standards for structures subject to its provisions. Design professionals, building inspectors, contractors and builders have various responsibilities for ensuring compliance.

In many jurisdictions, successfully passing a final building inspection is a prerequisite to the issuance of a certificate of occupancy. Construction agreements often require final approval by building inspectors for final contract payments. Building inspections typically involve making observations and taking measurements of the structure being inspected, which can be time-consuming when done with tape measures, levels and other conventional hand tools. Heretofore there has not been available a measuring tool particularly configured for determining construction document and building code compliance with the advantages and features of the present invention.

### SUMMARY OF THE INVENTION

In practicing an aspect of the present invention, a measuring tool is provided with upper and lower ends, respectively mounting upper and lower feet. A telescoping, tubular shaft assembly extends between the feet and includes an outer tube telescopically an inner tube. The tubes are provided with markings for measuring the tool overall length.

### BRIEF DESCRIPTION OF THE DRAWINGS

The drawings constitute a part of this specification and include exemplary embodiments of the present invention illustrating various objects and features thereof.

FIG. 1 is an upper, perspective view of a measuring device embodying an aspect of the present invention.

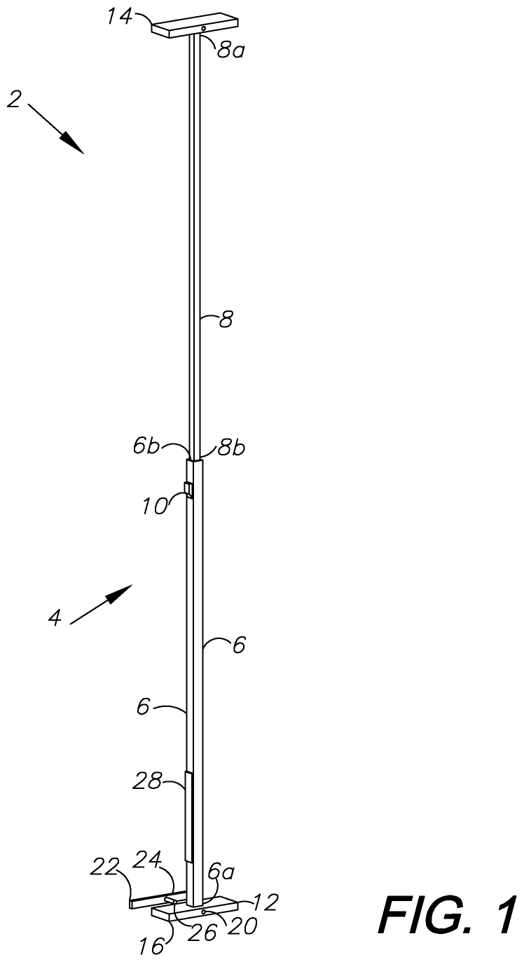

FIG. 2 is a side elevational view of the measuring tool.

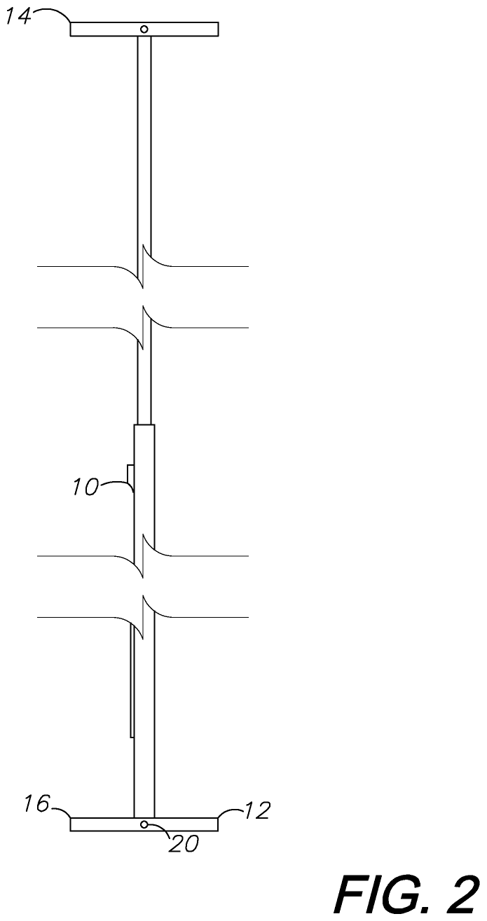

FIG. 3 is a fragmentary, side elevational view of the tool, particularly showing an outer tube and foot.

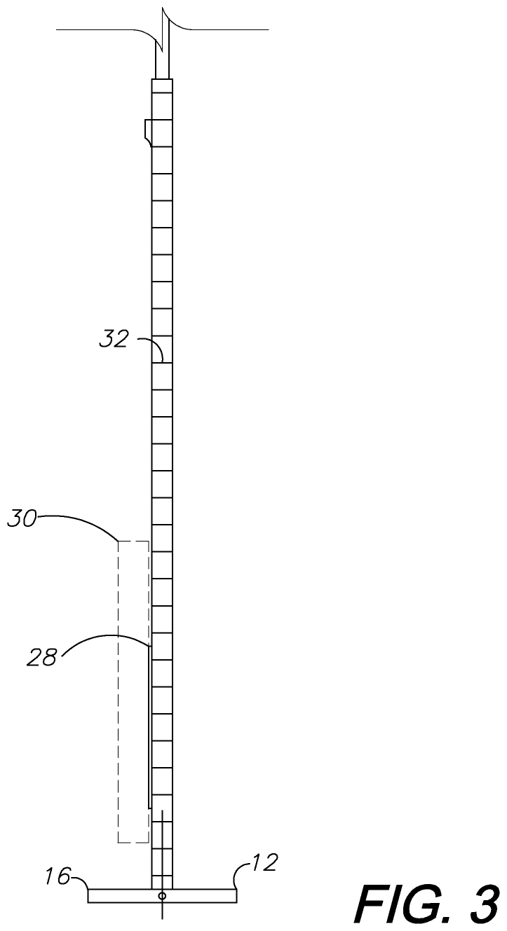

FIG. 4 is a fragmentary, front elevational view of the tool, particularly showing the outer tube and foot.

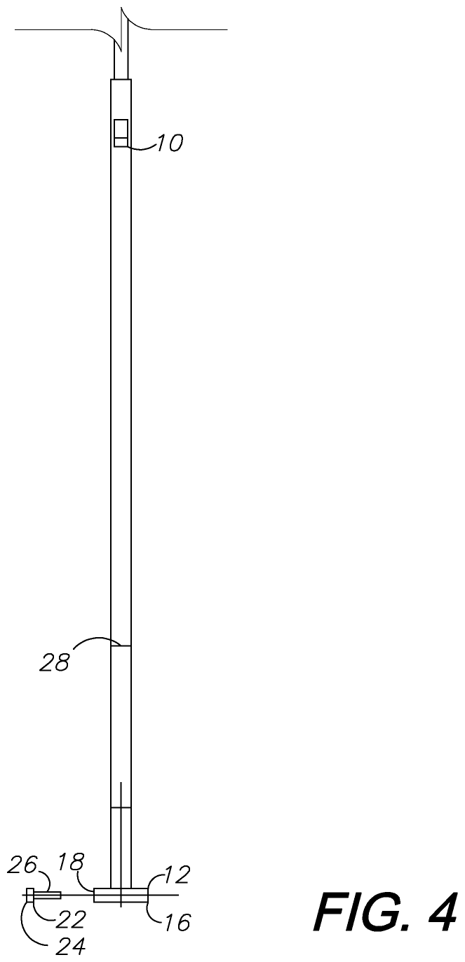

FIG. 5 is a fragmentary, side elevational view of the tool, particularly showing an inner tube thereof.

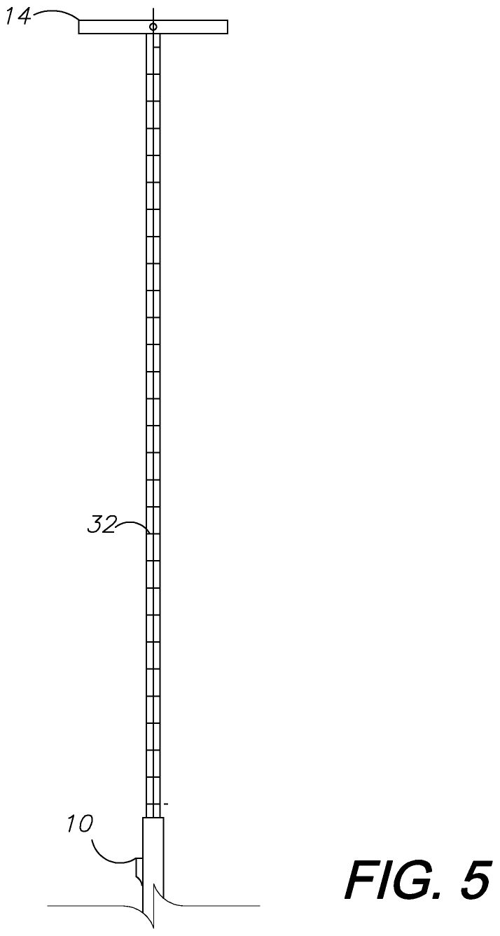

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Said terminology will include the words specifically mentioned, derivatives thereof and words of similar meaning.

### II. Measuring Tool 2

A measuring tool 2 generally comprises a telescoping, tubular assembly 4 with an outer tube 6 with first and second ends 6a and 6b, respectively, and an inner tube 8 with first and second ends 8a and 8b, respectively. The inner tube second end 8b is inserted into the outer tube second end 6b. The overall length of the tubular assembly 4 is adjustable by extending and retracting the inner tube 8 relative to the outer tube 6. A thumb-actuated lock 10 releasably secures the tubes 6, 8, in a fixed position relative to each other.

First and second foot assemblies 12, 14 are respectively mounted on the tube first ends 6a and 8a respectively. Each foot assembly 12, 14 includes a base 16 with a generally six-sided rectangular configuration. Each base 16 includes a receiver 20 open at a respective base side face 18. A pair of swivel pads 22 each includes a panel 24 and a swivel pad pin 26 extending from said panel 24. The pins 26 are removably inserted in respective receivers 20. The outer tube 6 mounts a magnetic strip 28 configured for magnetically, removably mounting a level 30.

Measuring indicia 32 are placed on faces of the outer and inner tubes 6, 8, and can include metric and/or English indicia. The measuring scheme is adaptable to user needs. By way of a nonlimiting example, the length of the outer tube 6 can be 2′-6″ and the first foot assembly base 16 can be 0.5 inches (½″) thick. The distance that the inner tube 8 extends plus the second foot base assembly thickness would then be added to 26½ inches for the overall measured length of the measuring tool 2. Such overall length could be printed on one or more side faces of the inner tube 8. A user, e.g., design professional, contractor or building inspector, could thus quickly read the overall dimension of an item being measured. The measuring indicia can be mirrored on one or more sides of the tubes 6, 8.

Building codes typically specify certain dimensions in structures for accessibility, safety and convenience to occupants and users. For example, exterior ingress-egress door openings are commonly 36 inches wide. Interior door opening widths are also codified. Light switches and electrical receptacles are commonly specified at 48 and 15 inches above the floor, respectively. Other dimensions in various rooms are commonly specified. For example, building codes commonly specify dimensions for layouts and components in kitchens, bathrooms and other rooms. Moreover, turning radii for wheelchairs are covered by building codes.

### III. Construction and Operation

The measuring tool 2 and its components can be constructed from readily available materials, such as steel, aluminum and hard plastic (e.g., Acrylonitrile Butadiene Styrene (ABS) plastic). The foot assemblies 12, 14 and the swivel pad panels 24 can be fabricated from rubber and other anti-slip materials.

In measuring operations, a user extends the tool 2 across and vertically in door openings to verify code compliance. With the level 30 in place, slopes can be determined, e.g., for ramp accessibility. In a level configuration, structural assemblies, e.g., walls, floors, ceilings, roofs, etc., can be analyzed for compliance with codes and construction documents. Still further, lasers, sonar range-finders and other components

### IV. Alternative Embodiment, Measuring Tools

Various alternative constructions of measuring tools are covered by this application. For example, the foot assemblies 12, 14 can be rotatably mounted on the tubular assembly 4 telescopically to accommodate sloping floors and other conditions, and can include protractors. As noted above, the measuring tool 2 can include metric measurement markings. Moreover, the outer and inner tubes can have circular and other multi-sided cross-sectional configurations.

### V. Conclusion

It is to be understood that the invention can be embodied in various forms and is not to be limited to the examples specifically discussed above. The range of components and configurations which can be utilized in the practice of the present invention is virtually unlimited.

Having thus described the invention, what is claimed as new and desired to be secured by Letters Patent is:

1. A measuring tool, which comprises:
a telescoping tubular assembly including an outer tube with first and second ends and an inner tube with first and second ends;
said outer tube telescopically receiving said inner tube;
a first foot assembly mounted on said outer tube first end;
a second foot assembly mounted on said inner tube first end;
measuring indicia on said inner and outer tubes;
a magnetic strip mounted on said outer tube and generally aligned there with; and
a level magnetically, removably attached to said magnetic strip.

2. A measuring method comprising the steps of:
providing a measuring tool with outer and inner tubes;
providing said outer tube with first and second ends and said inner tube with first and second ends;
telescopically receiving said inner tube in said outer tube;
placing said measuring tool between two structural components; and
measuring a distance between said structural components.
